(19) United States
(12) Patent Application Publication
(10) Pub. No.: US 2026/0008006 A1
(43) Pub. Date: Jan. 8, 2026

(54) ELECTRIC AND NON-ELECTRIC COMBINED DEHUMIDIFIER

(71) Applicants: TMI, INC., Hwaseong-si, Gyeonggi-do (KR); DIOSEM, INC., Hwaseong-si, Gyeonggi-do (KR)

(72) Inventors: Kwang Chul BANG, Gunpo-si (KR); Dong Seon WOO, Hwaseong-si (KR)

(21) Appl. No.: 18/765,182

(22) Filed: Jul. 5, 2024

(51) Int. Cl. B01D 53/26

(52) U.S. Cl. CPC B01D 53/265; B01D 2257/80; B01D 2258/0216; B01D 2259/652

(57) ABSTRACT

The present invention relates to an electric and non-electric combined dehumidifier in which, even though an electric dehumidifier that consumes an allowable margin electricity is used in an industrial site where it is previously installed and has difficulty in increasing the electric capacity, a non-electric dehumidifier that does not use electricity is used together when the dehumidification performance is insufficient, thereby capable of improving dehumidification performance.

### FIELD OF THE INVENTION

The present invention relates to a dehumidifier that is mounted to a scrubber and installed in the path where discarded harmful gases are discharged to remove moisture contained in the harmful gases, and more particularly, to an electric and non-electrical combined dehumidifier that combines a dehumidifying function that uses electricity and a dehumidifying function that does not use electricity.

### BACKGROUND OF THE INVENTION

In the semiconductor manufacturing process, a pattern is formed on a wafer by an etching method which involves heating the wafer to a high temperature and then corroding the surface of the wafer using hydrogen fluoride. The waste gas used in this way is burned at high temperature during the pattern forming process and thus becomes a harmful gas. Before harmful gases discarded after use in semiconductor manufacturing plants as well as other industrial fields are discharged to the outside, they are treated in accordance with environmental law regulations in a purification device such as a scrubber, and then discharged to the outside.

As shown in FIG. 1, the scrubber has a built-in plasma device that applies high temperature heat of about 1,000° C. to the harmful gas to separate the harmful gas into atomic nuclei and free electrons, making them into an ionized state to produce a treated gas with reduced pollution, and the pump injects liquid under pressure into the high-temperature treated gas, lowering the temperature to about 30˜40° C. Since the injected liquid is evaporated and consumed by the high-temperature treated gas, a supplementary liquid is filled by the amount consumed. When the supplementary liquid is filled, it is sprayed into the treatment gas, and the powder and residual impurities remaining in the treated gas are removed along with the liquid. After that, the treated gas becomes water vapor containing a lot of moisture due to the supplementary liquid, and impurities in the form of powder still remain in this water vapor, so that the moisture is removed using a dehumidifier and then discharged to the outside.

In relation to a conventional dehumidifier that is mounted on a scrubber to dehumidify moisture, Korean Unexamined Patent Publication No. 10-2020-0108712, published Sep. 21, 2020 (hereinafter referred to as “Patent Literature 1”) discloses a dehumidifying device for a scrubber.

According to Patent Literature 1, the thermoelectric element cools a refrigerant circulating through a thermoelectric cooling unit and a cooling coil, and when the low-temperature cooling coil, whose temperature has been lowered by the cooled refrigerant, comes into contact with the harmful gas passing through the dehumidifying housing, moisture contained in harmful gases is condensed, collected, and removed.

However, Patent Literature 1 is only equipped with an electric dehumidifier function using a thermoelectric element, and does not have a non-electric dehumidification function that does not use electricity. Therefore, there is a problem that it cannot be applied in an environment where the device is already installed and only surplus electricity with a limited electrical capacity is used.

More specifically, even though Patent Literature 1 exerts its dehumidifying function to its fullest extent by using the allowable margin electricity per unit of manufacturing device in a semiconductor manufacturing plant that is previously installed and has difficulty in increasing the electric capacity, it does not have any further dehumidifying means if it is not enough to remove a lot of moisture present in the harmful gas, and thus is not suitable for use. If the electric dehumidifier of Patent Literature 1 is used in such a special environment, a non-electric dehumidifier that does not use electricity, i.e., a water-cooled dehumidifier, must be additionally installed. Therefore, this requires a lot of costs and time for installation, and two electric and non-electric dehumidifiers must be installed in a small space, and thus, the problem that space becomes narrower cannot be avoided.

### PRIOR ART LITERATURE

### Patent Literature

(Patent Literature 0001) Korean Unexamined Patent Publication No. 10-2020-0108712

### SUMMARY OF THE INVENTION

Therefore, the present invention has been designed to solve various problems of a conventional dehumidifier as described above, and therefore an object of the present invention is to provide an electric and non-electric combined dehumidifier in which, even though an electric dehumidifier that consumes an allowable margin electricity is used in an industrial site where it is previously installed and has difficulty in increasing the electric capacity, a non-electric dehumidifier that does not use electricity is used together when the dehumidification performance is insufficient, thereby capable of improving dehumidification performance.

Another object of the present invention is to provide an electric and non-electric combined dehumidifier in which an electric dehumidifier and a non-electric dehumidifier are separated inside the housing through which harmful gases flow, and the harmful gases that are primarily dehumidified in the non-electric dehumidifier is transferred to the electric dehumidifier in a cooled state through passing through the primary dehumidification process, and are further cooled at that place, thereby capable of reaching a dew point in a short time during secondary dehumidification and further enhancing the dehumidification efficiency.

In order to achieve the above objects, according to the present invention, there is provided an electric and non-electric combined dehumidifier comprising:
a housing in which inlet/outlet ports are penetrated at both ends so as to communicate with an internal space through which harmful gas passes, and first and second storage chambers sealed with lids are provided on both side surfaces connected to both ends, so that cooling water supplied from the outside can be stored in a position close to the inlet;
a cooling water pipe in which a plurality of pipes are arranged in parallel to be exposed to the internal space of the housing, and are assembled so that each one end communicates with the first storage chamber and the other end communicates with the second storage chamber;
a cooling plate which is assembled on both ends and both side surfaces to close the open portion of the housing, and on which a plurality of cooling fins are protruded so as to be separated from the cooling water pipe and disposed while being exposed to the internal space close to the outlet;
a thermoelectric element in which the temperature of one side surface decreases by supply of electric power to become a cooling surface, the temperature of the other side surface rises to become a heat dissipation surface, and the cooling surface cools the cooling plate and the cooling fins; and
a heat dissipation block which is fixed in contact with the heat dissipation surface of the thermoelectric element to cool the heat dissipation surface,
wherein cooling water supplied from the outside cools the cooling water pipe to a temperature lower than the harmful gas temperature while circulating through the first storage chamber, the cooling water pipe, and the second storage chamber, and the cooled cooling water pipe collects moisture contained in the harmful gas and is primarily dehumidified while coming into contact with the harmful gas flowing into the internal space of the housing through the inlet, and
wherein, when the cooling fins cooled to a temperature lower than that of the cooling water pipe by the thermoelectric element comes into contact with harmful gases transferring to the outlet after the primary dehumidification, moisture that has not been dehumidified in the first dehumidification is collected and secondarily dehumidified.

In the present invention, a gasket may be adhesively fixed between the cooling plate and the heat dissipation block in a state in which the thermoelectric element is housed inside so that external air does not penetrate into the thermoelectric element.

In the present invention, the first and second storage chambers are each equipped with hose connection ports as so to communicate with the first and second storage chambers, so that cooling water can be supplied or discharged, and a plurality of holes are penetrated at the position where the cooling water pipe is inserted.

In the present invention, when harmful gas passes through the internal space of the housing, the portion exposed to the harmful gas is coated with a corrosion-preventing material.

In the present invention, the cooling water pipe is cut so that slots for guiding the inflow of cooling water at both ends are communicated with the internal space, and both ends of the slot are joined by brazing to the covers of the first and second storage chambers corresponding thereto.

In the present invention, the cooling plate forms a tab at a position where the cooling fin protrudes, and fastens and fixes the cooling fin to the tab, or forms a fitting hole at the position where the cooling fin protrudes, and assemble the cooling fin into the fitting hole in an interference fit manner.

The thermoelectric element of the present invention is housed inside a case in a state in which the cool block is closely mounted on the cooling surface, the housing is fixed to the heat dissipation block so that the cool block is assembled to the cooling plate so that the heat dissipation surface is closely adhered to the heat dissipation block, and the elastic member built into the case pushes the cool block toward the thermoelectric element, thereby increasing the close adhesion between the cool block and the cooling surface of the thermoelectric element.

The heat dissipation block of the present invention has a structure in which a plurality of passages are penetrated inside the body along the longitudinal direction, both ends of the passages are closed by a cover, both sides of the body in the transverse direction are formed with an inlet passage and an outlet passage so as to be in communication with the passage, so that cooling water can enter and exit the passage.

The present invention configured as described above has advantages in that, even though an electric dehumidifier that consumes a limited margin electricity is used to the maximum extent in an industrial site where it has difficulty in increasing the electric capacity, when the dehumidification performance of the electric dehumidifier is insufficient, a non-electric dehumidifier using no electricity installed inside the dehumidifier helps with dehumidification, and can achieve a higher dehumidification efficiency than an electric dehumidifier used alone.

The present invention also has advantages in that an electric dehumidifier and a non-electric dehumidifier are mounted together in one boy in a separated state, whereby not only a non-electrical dehumidifier cools a cooling water pipe by using cooling water cooled by a cooling tower and primarily dehumidifies the moisture contained in harmful gases, but also harmful gases, which have been gradually cooled to a lower temperature through passing through the primary dehumidification process, are transferred to an electric dehumidifier, and dehumidified in a short time when they come into contact with the cooling fins at that place, thereby capable of further enhancing the dehumidification efficiency.

### BRIEF DESCRIPTION OF THE DRAWINGS

FIG. 1 is an image showing the inside of a scrubber.

FIG. 2 is an image of the present invention installed in the scrubber of FIG. 1.

FIG. 3 is an exploded perspective view of the dehumidifier of the present invention.

FIG. 4 is a perspective view showing the housing of the present invention.

FIG. 5 is a perspective view showing a state in which a cooling water pipe is assembled in the housing of the present invention and cooling plates are separated on both sides of the housing.

FIG. 6 is a cooling plate diagram showing the arrangement state of the cooling fins of the present invention.

FIG. 7 is a perspective view of a cooling plate assembled in the housing of FIG. 5.

FIG. 8 is an assembled perspective view of the present invention.

FIG. 9 is a front cross-sectional view showing the inside of the present invention.

FIG. 10 is a right cross-sectional view showing a non-electric dehumidifier according to the present invention.

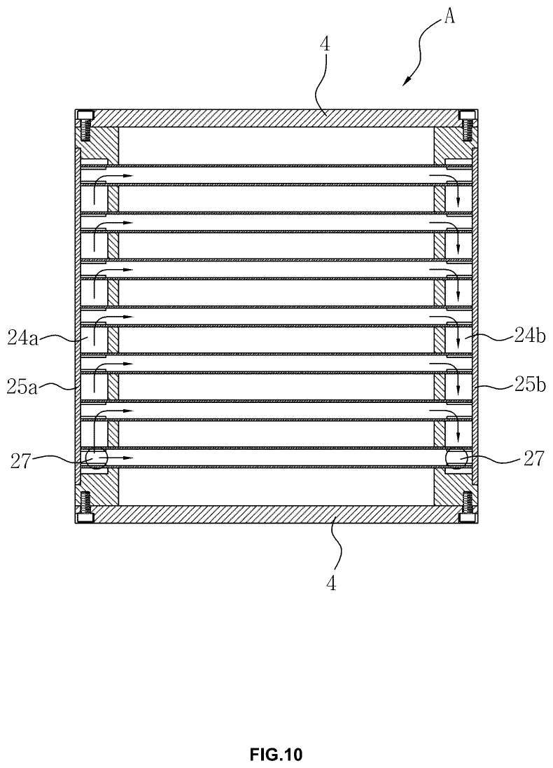

FIG. 11 is an enlarged view showing a state in which the cooling pipe of the present invention is attached to the cover of the first storage chamber.

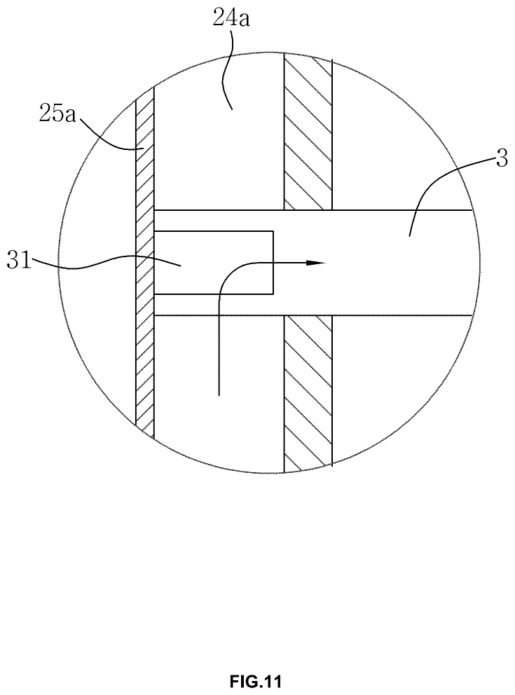

FIG. 12 is a right cross-sectional view showing an electric dehumidifier according to the present invention.

FIG. 13 is an imaged photograph of the thermoelectric element, housing, and cool block of the present invention.

FIG. 14 is a cross-sectional view showing the assembled state of the thermoelectric element of the present invention

FIG. 15 is a cross-sectional plan view of the heat dissipation block of the present invention.

FIG. 16 is a right cross-sectional view of the heat dissipation block of the present invention.

FIG. 17 is a front cross-sectional view showing the state of use of the present invention.

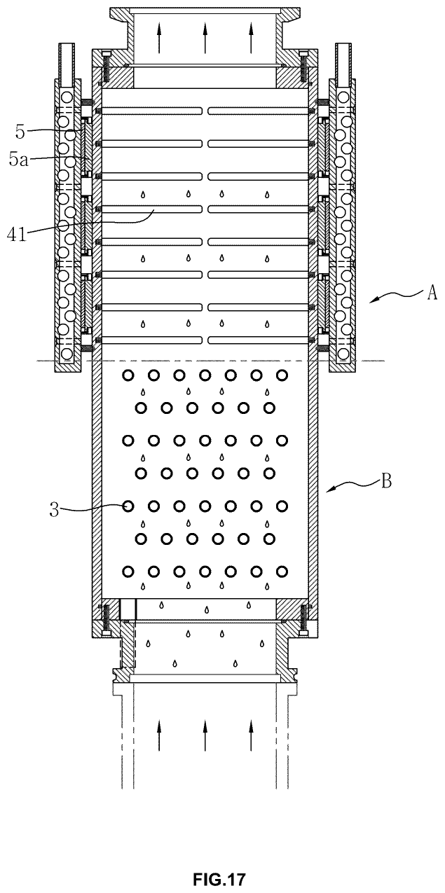

### DETAILED DESCRIPTION OF THE INVENTION

Hereinafter, the configuration of an electric and non-electric combined dehumidifier of the present invention will be described with reference to the accompanying drawings.

As show in the figures, an electric and non-electric combined dehumidifier 1 of the present invention comprises:
a housing 2 in which inlet/outlet ports 23a and 23b are penetrated at both ends 22 so as to communicate with an internal space 21 through which harmful gas passes, and first and second storage chambers 24a and 24b sealed with lids 25a and 25b are provided on both side surfaces 24 connected to both ends 22, so that cooling water supplied from the outside can be stored in a position close to the inlet 23a;
a cooling water pipe 3 in which a plurality of pipes are arranged in parallel to be exposed to the internal space 21 of the housing 2, and are assembled so that each one end communicates with the first storage chamber 24a and the other end communicates with the second storage chamber 24b;
a cooling plate 4 which is assembled on both ends 22 and both side surfaces 24 to close the open portion of the housing 2, and on which a plurality of cooling fins 41 are protruded so as to be separated from the cooling water pipe 3 and disposed while being exposed to the internal space 21 close to the outlet port 23b;
a thermoelectric element 5 in which the temperature of one side surface decreases by supply of electric power to become a cooling surface, the temperature of the other side surface rises to become a heat dissipation surface, and the cooling surface cools the cooling plate 4 and the cooling fins 41; and
a heat dissipation block 6 which is fixed in contact with the heat dissipation surface of the thermoelectric element 5 to cool the heat dissipation surface,
wherein cooling water supplied from the outside cools the cooling water pipe 3 to a temperature lower than the harmful gas temperature while circulating through the first storage chamber 24a, the cooling water pipe 3, and the second storage chamber 24b, and the cooled cooling water pipe 3 collects moisture contained in the harmful gas and is primarily dehumidified while coming into contact with the harmful gas flowing into the internal space 21 of the housing 2 through the inlet 23a, and
wherein, when the cooling fins 41 cooled to a temperature lower than that of the cooling water pipe 3 by the thermoelectric element 5 comes into contact with harmful gases transferring to the outlet port 23b after the primary dehumidification, moisture that has not been dehumidified in the first dehumidification is collected and secondarily dehumidified.

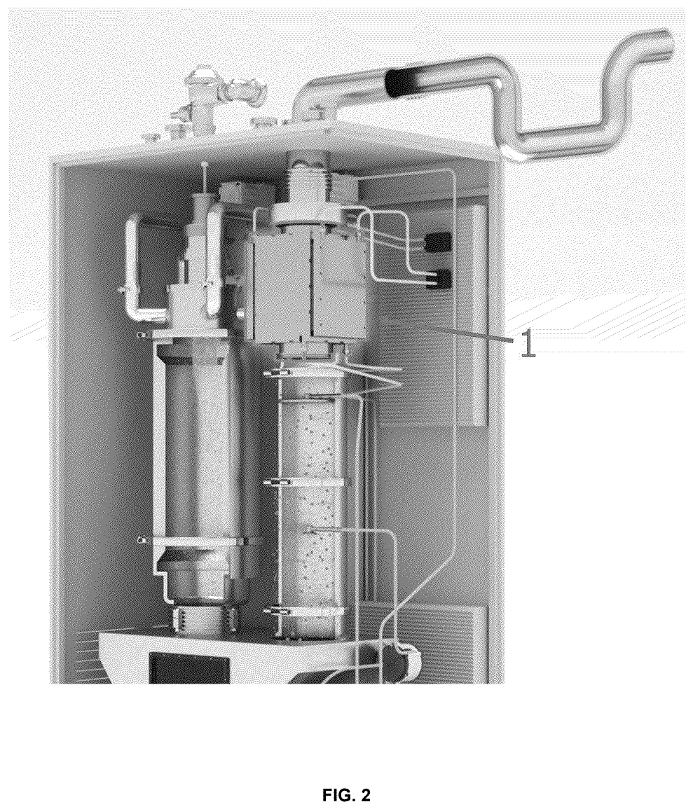

FIG. 2 is an image of one embodiment showing that the dehumidifier 1 of the present invention is assembled on the upper part of a scrubber passage and dehumidifies harmful gases discharged through the passage.

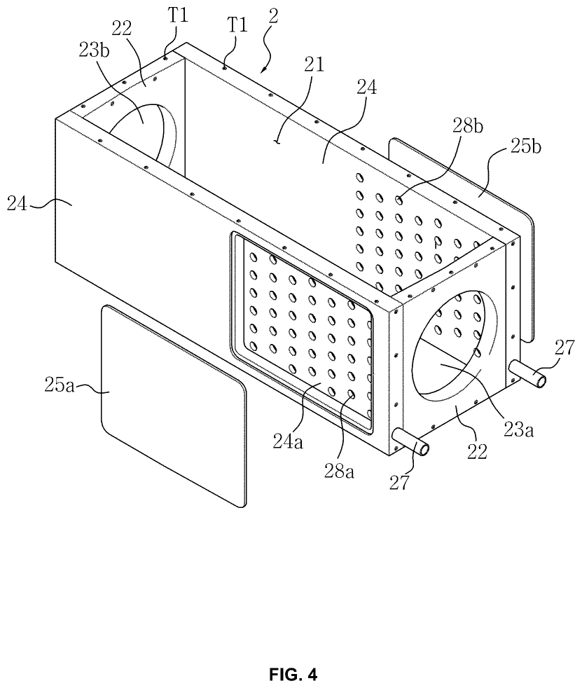

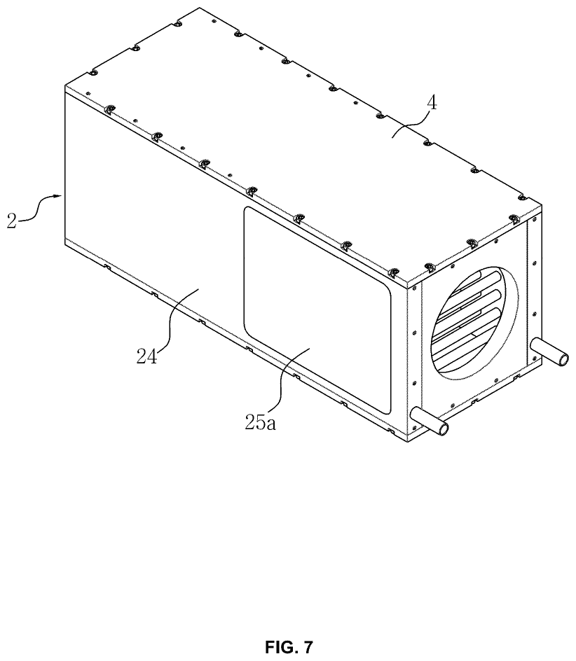

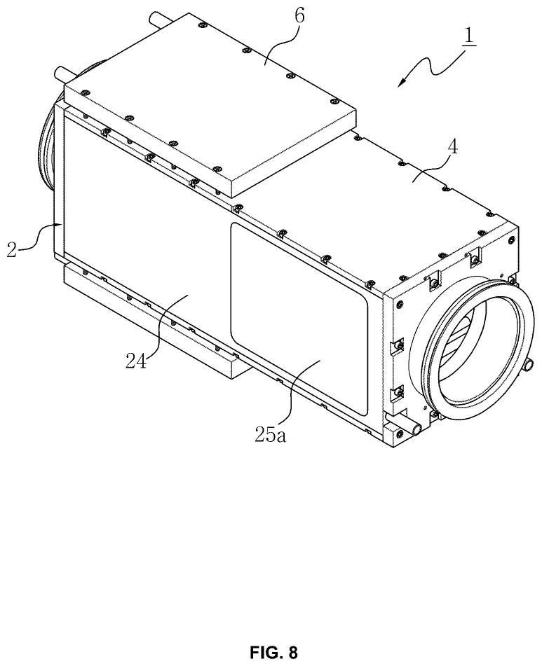

FIG. 4 shows the housing 2 of the present invention. The housing 2 provides a path through which harmful gas passes. As shown in the figure, inlet/outlet ports 23a and 23b are penetrated at both ends 22 so as to communicate with an internal space 21 through which harmful gas passes, and first and second storage chambers 24a and 24b sealed with lids 25a and 25b are provided on both side surfaces 24 connected to both ends 22, so that cooling water supplied from the outside can be stored in a position close to the inlet 23a. The first and second storage chambers 24a and 24b are each equipped with hose connection ports 27 as so to communicate with the first and second storage chambers 24a and 24b, so that cooling water can be supplied or discharged, and a plurality of holes 28a and 28b are penetrated at the position where the cooling water pipe 3 is inserted. When the cooling water pipes 3 are fitted into the holes 28a and 28b of the first and second storage chambers 24a and 24b to complete the assembly, the open portions of the first and second storage chambers 24a and 24b are closed with covers 25a and 25b as shown in FIGS. 7 and 8, wherein the covers 25a and 25b are joined by brazing. Tabs T1 are formed at the ends of both ends 22 and both side surfaces 24 of the housing 2 so that the cooling plate 4 can be fastened and fixed thereto. A hose (not shown) for guiding circulation of cooling water is connected to the hose connecting port 27 assembled in the first and second storage chambers 24a and 24b. For reference, the hose is connected to a cooling tower in a factory, so that the cooling water cooled in the cooling tower can be used as a refrigerant.

The housing 2 is cooled by cooling water flowing through the cooling water pipe 3 or a thermoelectric element 5 described below, and a metal material with excellent thermal conductivity can be used to collect and dehumidify moisture contained in harmful gases. As an example, copper or aluminum can be used.

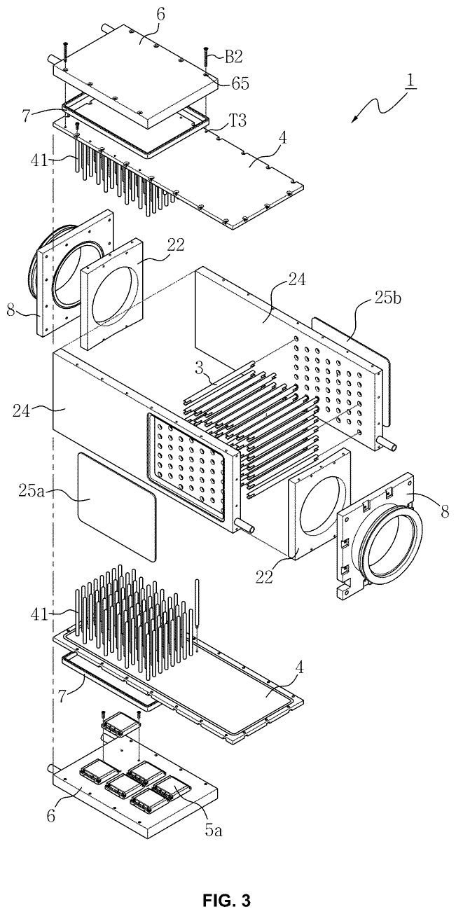

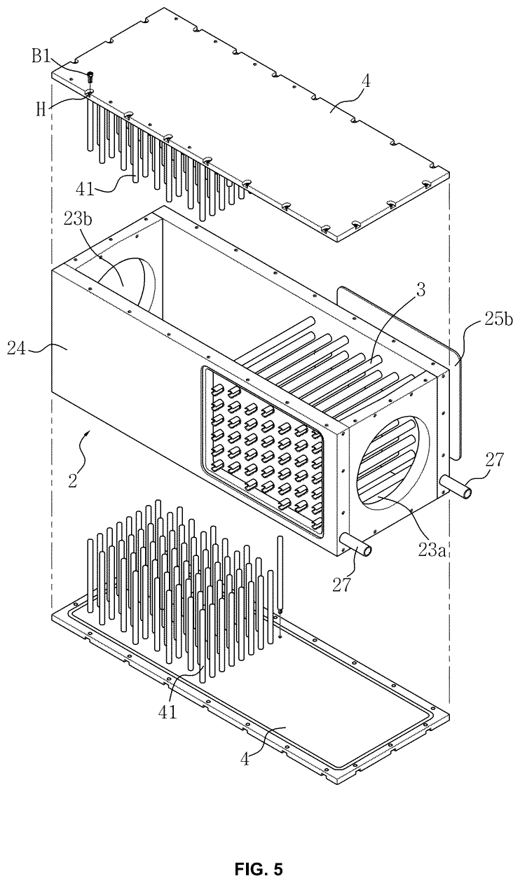

The cooling water pipes 3 are an important element constituting a non-electric dehumidifier. As shown in FIGS. 3 and 5, a plurality of cooling water pipes 3 are arranged in parallel so that they are exposed to the internal space 21 of the housing 2, and assembled so that each one end communicates with the first storage chamber 24a and the other end communicates with the second storage chamber 24b. The cooling water pipe 3 is cut so that slots 31 for guiding the inflow of cooling water at both ends are communicated with the internal space, and both ends of the slot 31 are joined by brazing to the covers 25a and 25b of the first and second storage chambers 24a and 24b corresponding thereto. When the assembly of the cooling water pipe 3 is completed, the slots 31 located on both sides communicate with the first and second storage chambers 24a and 24b, so that the cooling water supplied to the first storage chamber 24a is transferred to the inside of the cooling water pipe 3, and then discharged to the second storage chamber 24b. Therefore, the cooling water circulates through the cooling tower and the cooling water pipe 3.

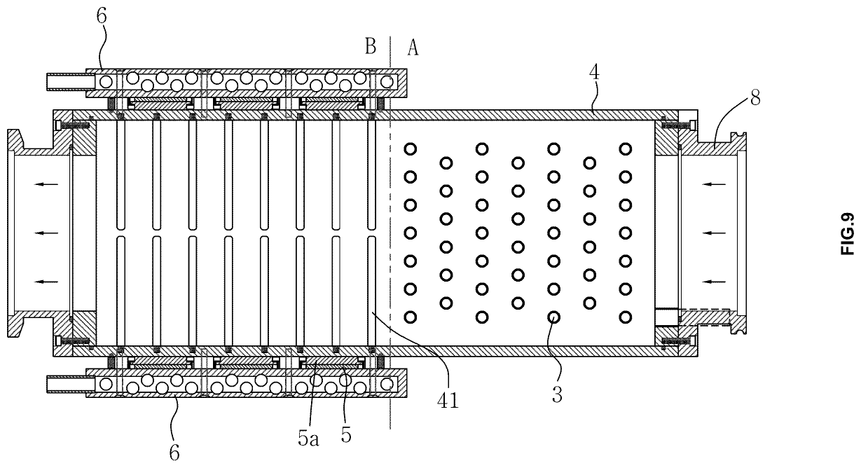

It is preferable that the plurality of cooling water pipes 3 arranged in parallel are arranged to be staggered with adjacent ones so as to be well exposed to harmful gases moving in the direction of the arrow as shown in FIG. 9. In addition, since the cooling water pipe 3 constitutes a non-electric dehumidifier and thus does not use electricity, the object of the present invention can be achieved even if the water quantity is increased according to the dehumidification conditions. Since the cooling water pipe 3 performs a kind of heat exchange function, it is preferable to use a material with excellent thermal conductivity, and as an example, the same material as the housing 2 can be used.

The cooling plate 4 is fastened and assembled to the openings on both sides of the housing 2 as shown in FIG. 5. The housing 2 in which the cooling plate 4 is assembled is configured such that the remaining portions except for the inlet/outlet ports 23a and 23b are closed for the first time, thereby providing an internal space 21. Therefore, the cooling plate 4 also functions as the housing 2.

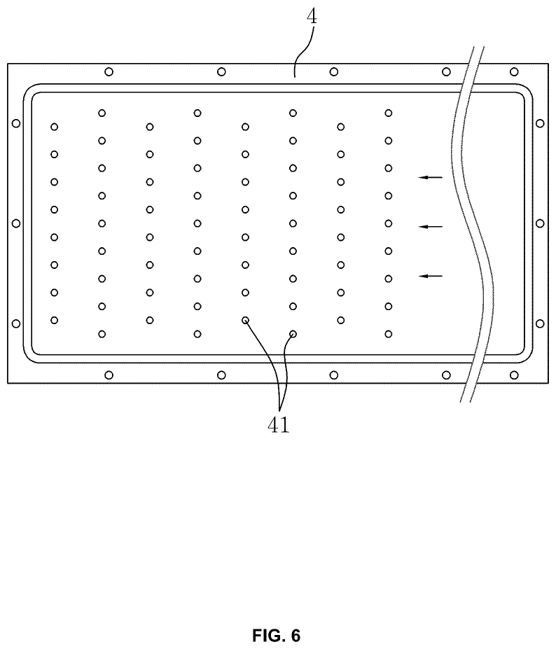

The cooling plate 4 must be smoothly finished because a plurality of cooling fins 41 are protruded so as to be separated from the cooling water pipe 3 and disposed while being exposed to the internal space 21 close to the outlet port 23b, and a thermoelectric element 5 that cools the cooling plate 4 is mounted on the outer side surface opposite to the cooling fin 41. The cooling fins 41 are preferably arranged to be staggered from adjacent ones so that they can be well exposed to harmful gases moving in the direction of the arrow, as shown in FIG. 6.

Since the cooling fins 41 have a considerable length, a considerable amount of material would be wasted for forming them as one piece with the cooling plate 4, which is thus not preferable. Therefore, it is preferable that the cooling fins 41 be composed of two pieces that are separately constructed and assembled to the cooling plate 4. For example, a tab T2 is formed at the position of the cooling plate 4 where the cooling fin 41 protrudes, and the cooling fin 41 is fastened and fixed to the tab T2, or a fitting hole (not shown) is formed at a position where the cooling fin 41 protrudes, and the cooling fin 41 is assembled into the fitting hole in a pressure-fitting manner, so that the cooling fin 41 can be assembled to protrudes onto the cooling plate 4.

A fastening hole H is penetrated through the edge of the cooling plate 4 to match with the tabs T1 formed on both ends 22 and both side surfaces 24 of the housing 2 so that the bolt B1 can be fastened. At the position where the heat dissipation block 6 is assembled, a tab T3 is formed to fasten and fix the heat dissipation block 6 with a bolt B2. Since the cooling plate 4 and the cooling fins 41 must be cooled by the thermoelectric element 5 to dehumidify the moisture contained in harmful gases, a metal material having excellent thermal conductivity can be used, and as an example, the same material as the housing 2 can be used.

The thermoelectric element 5 has a structure in which one side surface becomes a cooling surface as the temperature decreases by supply of electric power, the other side surface becomes a heat dissipation surface as the temperature rises, and the cooling surface cools the cooling plate 4.

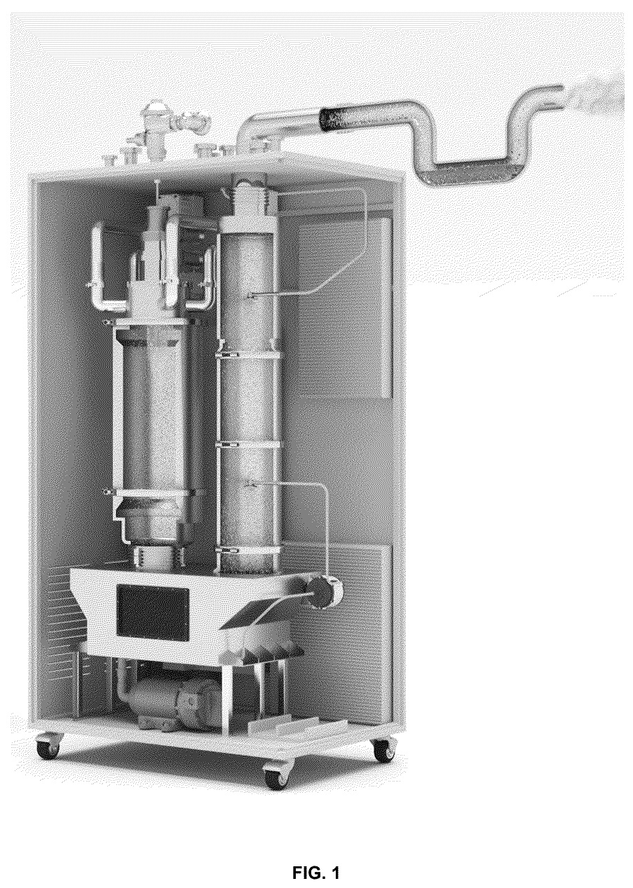

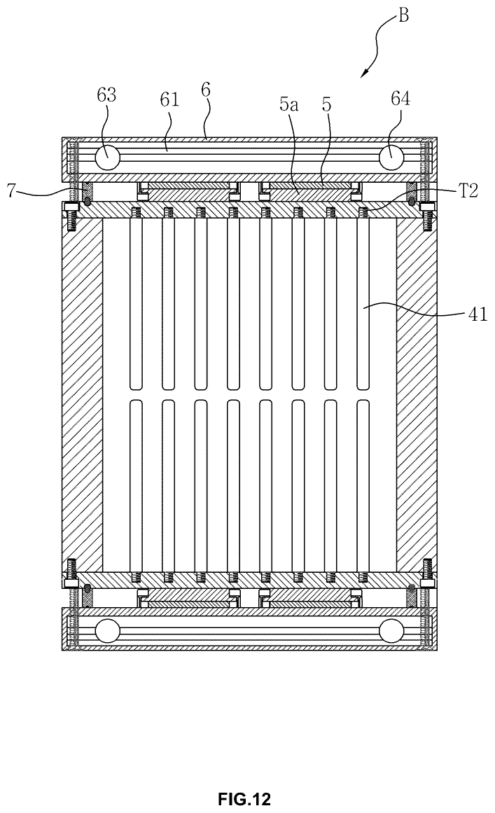

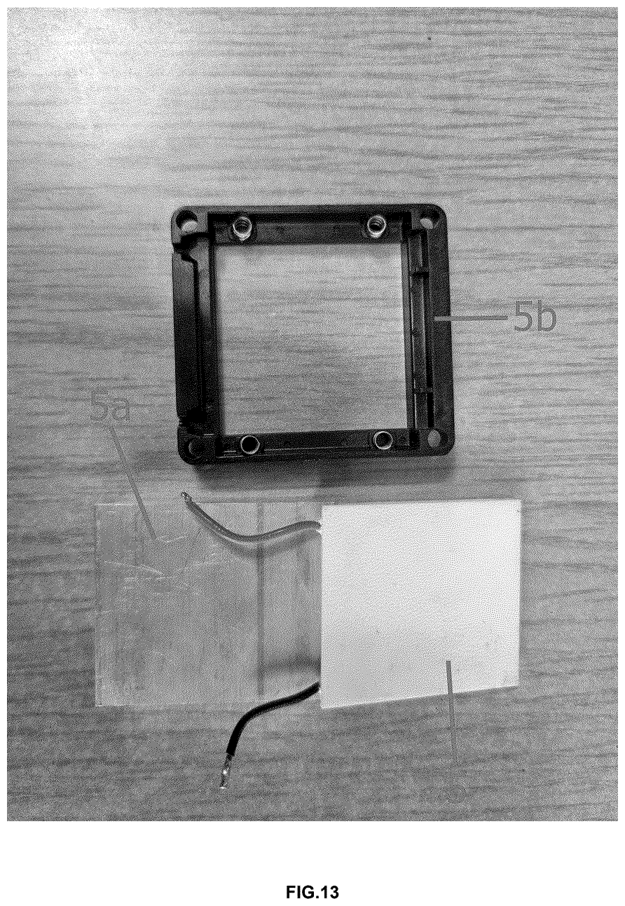

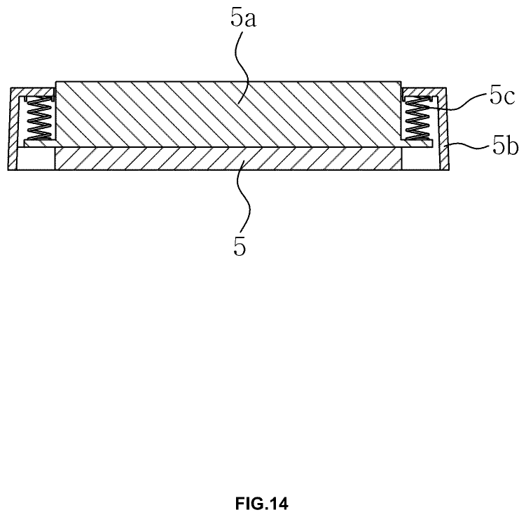

The thermoelectric element 5 is housed inside the case 5b in a state in which the cool block 5a is mounted on the cooling surface as shown in FIG. 1 and FIGS. 12 to 14, and the case 5b is first fixed to the heat dissipation block 6 so that the heat dissipation surface is closely adhered to the heat dissipation block 6. Subsequently, when the heat dissipation block 6 is fixed to the cooling plate 4 using bolts, the cool block 5a protruding to the outside of the case 5b is tightly adhered with the cooling plate 4. Since the compressive elastic member 5c built into the case 5b always pushes the cool block 5a toward the thermoelectric element 5, the close adhesion between the cool block 5a and the cooling surface of the thermoelectric element 5 is improved. Therefore, even if the thermal expansion coefficient are different due to the difference in materials between the case 5b and the cool block 5a, the elastic member 5c always tightly adheres the cool block 5a and the thermoelectric element 5, so that the cold heat of the thermoelectric element 5 is transferred well to the cooling plate 4 via the cool block 5a, thereby improving cooling efficiency.

Since the material of the cool block 5a transfers the cold heat of the thermoelectric element 5 to the cooling plate 4, a metal material having excellent thermal conductivity can be used. As an example, copper or aluminum can be used.

The heat dissipation block 6 is fixed in contact with the heat dissipation surface of the thermoelectric element 5 and cools the heat dissipation surface so that the cooling surface of the thermoelectric element 5 can continuously cool the cooling fin 41.

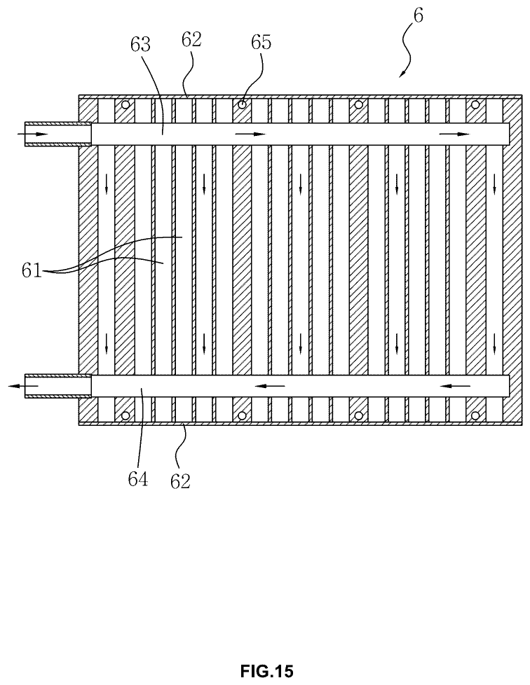

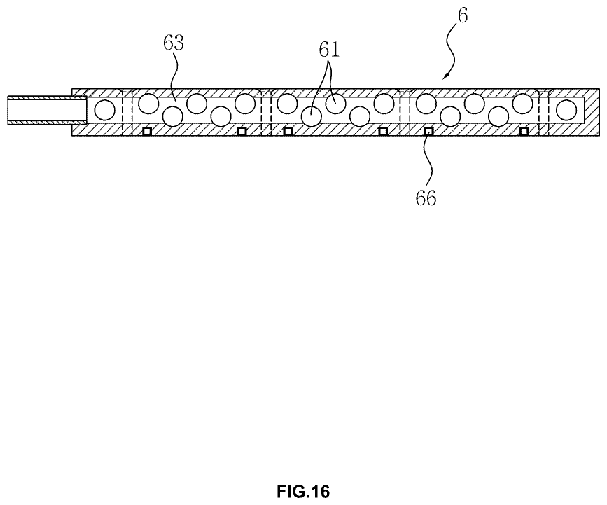

The heat dissipation block 6 is closely adhered to the heat dissipation surface of the thermoelectric element 5 and is cooled by the cooling water circulating through the internal passage 61, thereby cooling the heat dissipation surface of the thermoelectric element 5. As shown in FIGS. 15 and 16, the heat dissipation block 6 has a structure in which a plurality of passages 61 are penetrated inside the body along the longitudinal direction, both ends of the passages 61 are closed by a cover 62, both sides of the body in the transverse direction are formed with an inlet passage 63 and an outlet passage 64 so as to communicate with the passage 61 so that cooling water can enter and exit the passage 61. The edge of the body is fastened to the cooling plate 4 so that a fastening hole 65 is penetrated through which the second bolt B2 for fastening and fixing the heat dissipation block 6 to the cooling plate 4 is fastened. In addition, one side surface of the body of the heat dissipation block 6 is formed with a plurality of tabs 66 so as to fasten the case 5b of the thermoelectric element 5.

The passages 61 of the heat dissipation block 6 are preferably arranged densely in two stages as shown in FIG. 16 so as to allow a large amount of cooling water to flow widely. Further, since the heat dissipation block 6 must be quickly cooled by cooling water, it is made of a metal material having excellent thermal conductivity. As an example, copper or aluminum materials can be used.

In the heat dissipation block 6 configured as above, cooling water supplied from the cooling tower is supplied to the inlet passage 63 through the inlet port and then distributed and flows through a plurality of passages 61 and then collected to the outlet passage 64 and discharged back to the cooling tower through a hose. In this process, the cooling water flowing through the passage 61 of the heat dissipation block 6 cools the high temperature heat dissipation block 6 in a water-cooled manner, thereby continuously lowering the temperature of the heat dissipation surface of the thermoelectric element 5.

Meanwhile, according to the present invention, a gasket 7 may be adhesively fixed between the cooling plate 4 and the heat dissipation block 6 in a state in which the thermoelectric element 5 is housed inside so as to prevent external air from penetrating into the thermoelectric element 5. When as adhesive is applied to both side surfaces of the gasket 7 and one side surface is adhesively fixed to the cooling plate 4 and the other side surface to the heat dissipation block 6, airtightness is maintained and moist external air is blocked from the thermoelectric element 5 housed in the gasket 7.

Further, according to the present invention, when harmful gases pass through the internal space 21 of the housing 2, the portion exposed to the harmful gases may be coated with a corrosion preventing material. As an example of the corrosion prevention material, a parylene coating material can be used. Since the parylene coating material is a well-known element that is already widely used in the industrial field, a further detailed explanation thereof will be omitted.

Further, according to the present invention, flanges 8 may be further mounted on the outside of the inlet/outlet ports 23a and 23b on both sides of the housing 2. The flange 8 connects the pipe that guides the treatment gas discharged in the present invention, and this flange 8 is similar to a known shape, and therefore a further detailed description thereof will be omitted.

The following describes how the dehumidifier of the present invention dehumidifies moisture contained in harmful gas.

Referring to FIG. 9, the right side is a non-electric dehumidifier A, and the left side is an electric dehumidifier B. First, while the cooling water cooled in the external cooling tower circulates through the first storage chamber 24a, the cooling water pipe 3, and the second storage chamber 24b of the non-electric dehumidifier B, the housing 2 and the cooling water pipe 3 are cooled to a temperature lower than the harmful gas temperature. The cooling water pipe 3 is exposed to the internal space 21 of the housing 2 in a cooled state, and therefore, when the harmful gas passing through the inside of the housing 2 comes into contact with the cooling water pipe 3, the moisture contained therein is condensed and primarily dehumidified. Harmful gases that do not come into contact with the cooling water pipe 3 move in the direction of the electric dehumidifier. At this time, the harmful gas that does not come into contact with the cooling water pipe 3 but passes around it is cooled by the influence of the cooling water pipe 3 and the cooling fins 41 as it moves, and its temperature gradually drops to reach a dew point, which makes it easy to dehumidify with an electric dehumidifier. This condition is because the cooling water pipe 3 and the cooling fin 41 are separated on both sides.

Assuming that the harmful gas passing through the housing 2 in the primary dehumidification is about 40° C., and the cooling water pipe 3 cooled in the cooling tower is about 20° C., the temperature difference between them is 20° C., and therefore, the first dehumidification rate is achieved by this temperature difference.

The harmful gas whose moisture has been dehumidified through the first dehumidification passes through the final cooling water pipe 3, and then enters the area where cooling fins 41 with a lower temperature than the cooling water pipe 3 are gathered and is then discharged through the outlet port. During this process, when harmful gases come into contact with the cooling fins 41, they are condensed and the remaining moisture is condensed quickly and secondarily dehumidified.

Assuming that the harmful gas passing through the cooling water pipe 3 in the primary dehumidification is about 35° C. and the cooling fins 41 cooled by the cold heat of the thermoelectric element 5 using electricity are about 5° C., the temperature difference between them is 30° C. and therefore, the secondary dehumidification rate is achieved by this temperature difference. Since the electric dehumidifier B is cooled by the thermoelectric element 5, it is cooled up to a lower temperature than the cooling water pipe 3, and therefore has superior dehumidification performance.

If there is no problem with electricity use, a higher dehumidification rate can be expected if cooling fins 41 are arranged throughout the internal space 21 of the housing 2.

However, the present invention relates to a combined dehumidifier equipped with electric and non-electric dehumidifying functions that applies a water-cooled dehumidifier not using electricity in order to increase the dehumidification rate in an environment where limited spare electricity is used to the maximum extent, such as in a conventional semiconductor factory, and in particular, the major feature is that a non-electric dehumidifier A with a low dehumidification rate is arranged on the inlet side of the housing 2, and an electric dehumidifier B with a high dehumidification rate is installed on the outlet side, so that dehumidification is performed over twice to increase the dehumidification rate.

If an electric dehumidifier B is provided on the inlet port side 23a and dehumidifies at a low temperature from the primary dehumidification, in the secondary dehumidification, the temperature of the cooling water pipe 3 is higher than that of the cooling fins 41, and almost no dehumidification can be expected.

### DESCRIPTION OF REFERENCE NUMERALS

1: combined dehumidifier 2: housing
3: cooling water pipe 4: cooling plate
5: thermoelectric element 6: heat dissipation block

What is claimed is:

1. An electric and non-electric combined dehumidifier comprising:
a housing (2) in which inlet/outlet ports (23a, 23b) are penetrated at both ends (22) so as to communicate with an internal space (21) through which harmful gas passes, and first and second storage chambers (24a, 24b) sealed with lids (25a, 25b) are provided on both side surfaces (24) connected to both ends (22), so that cooling water supplied from the outside can be stored in a position close to the inlet (23a);
a cooling water pipe (3) in which a plurality of pipes are arranged in parallel to be exposed to the internal space (21) of the housing (2), and are assembled so that each one end communicates with the first storage chamber (24a) and the other end communicates with the second storage chamber (24b);
a cooling plate (4) which is assembled on both ends (22) and both side surfaces (24) to close the open portion of the housing (2), and on which a plurality of cooling fins (41) are protruded so as to be separated from the cooling water pipe (3) and disposed while being exposed to the internal space (21) close to the outlet port (23b);
a thermoelectric element (5) in which the temperature of one side surface decreases by supply of electric power to become a cooling surface, the temperature of the other side surface rises to become a heat dissipation surface, and the cooling surface cools the cooling plate (4) and the cooling fins (41); and
a heat dissipation block (6) which is fixed in contact with the heat dissipation surface of the thermoelectric element (5) to cool the heat dissipation surface,
wherein cooling water supplied from the outside cools the cooling water pipe (3) to a temperature lower than the harmful gas temperature while circulating through the first storage chamber (24a), the cooling water pipe (3), and the second storage chamber (24b), and the cooled cooling water pipe (3) collects moisture contained in the harmful gas and is primarily dehumidified while coming into contact with the harmful gas flowing into the internal space (21) of the housing (2) through the inlet (23a), and
wherein, when the cooling fins (41) cooled to a temperature lower than that of the cooling water pipe (3) by the thermoelectric element (5) comes into contact with harmful gases transferring to the outlet port (23b) after the primary dehumidification, moisture that has not been dehumidified in the first dehumidification is collected and secondarily dehumidified.

2. The electric and non-electric combined dehumidifier according to claim 1, wherein a gasket (7) is adhesively fixed between the cooling plate (4) and the heat dissipation block (6) in a state in which the thermoelectric element (5) is housed inside so that external air does not penetrate into the thermoelectric element (5).

3. The electric and non-electric combined dehumidifier according to claim 1, wherein the first and second storage chambers (24a, 24b) are each equipped with hose connection ports (27) as so to communicate with the first and second storage chambers (24a, 24b), so that cooling water can be supplied or discharged, and a plurality of holes (28a, 28b) are penetrated at the position where the cooling water pipe (3) is inserted.

4. The electric and non-electric combined dehumidifier according to claim 1, wherein when harmful gas passes through the internal space (21) of the housing (2), the portion exposed to the harmful gas is coated with a corrosion-preventing material.

5. The electric and non-electric combined dehumidifier according to claim 1, wherein the cooling water pipe (3) is cut so that slots (31) for guiding the inflow of cooling water at both ends are communicated with the internal space, and both ends of the slot (31) are joined by brazing to the covers (25a, 25b) of the first and second storage chambers (24a, 24b) corresponding thereto.

6. The electric and non-electric combined dehumidifier according to claim 1, wherein the cooling plate (4) forms a tab (T2) at a position where the cooling fin (41) protrudes, and fastens and fixes the cooling fin (41) to the tab (T2), or forms a fitting hole at the position where the cooling fin (41) protrudes, and assemble the cooling fin (41) into the fitting hole in an interference fit manner.

7. The electric and non-electric combined dehumidifier according to claim 1, wherein the thermoelectric element (5) is housed inside a case (5b) in a state in which the cool block (5a) is closely mounted on the cooling surface, the housing (2) is fixed to the heat dissipation block 6 so that the cool block (5a) is assembled to the cooling plate (4) so that the heat dissipation surface is closely adhered to the heat dissipation block (6), and the elastic member (5c) built into the case (5b) pushes the cool block 5a toward the thermoelectric element (5), thereby increasing the close adhesion between the cool block (5a) and the cooling surface of the thermoelectric element (5).

8. The electric and non-electric combined dehumidifier according to claim 1, wherein the heat dissipation block (6) has a structure in which a plurality of passages (61) are penetrated inside the body along the longitudinal direction, both ends of the passages (61) are closed by a cover (62), both sides of the body in the transverse direction are formed with an inlet passage (63) and an outlet passage (64) so as to be in communication with the passage (61), so that cooling water can enter and exit the passage (61).
